(19) United States
(12) Patent Application Publication
(10) Pub. No.: US 2015/0231839 A1
(43) Pub. Date: Aug. 20, 2015

(54) LENSES WITH GRADED PHOTOCHROMIC, MOLDS AND METHODS OF MAKING SAME

(71) Applicant: QSpex Technologies, Inc., Alpharetta, GA (US)

(72) Inventors: Kai C. Su, Alpharetta, GA (US); Leslie F. Stebbins, Roswell, GA (US); Dionisio Cruz, Buford, GA (US); Jessica L. Gettings, Johns Creek, GA (US)

(21) Appl. No.: 14/626,473

(22) Filed: Feb. 19, 2015

Related U.S. Application Data
(60) Provisional application No. 61/942,246, filed on Feb. 20, 2014.

(51) Int. Cl. B29D 11/00; G02C 7/02; G02C 7/10; G02B 1/14; B29C 39/02

(52) U.S. Cl. CPC B29D 11/0048; G02B 1/14; B29C 39/026; G02C 7/102; G02C 7/02; B29L 2011/0066

(57) ABSTRACT

Certain aspects of the invention are directed to a photochromic lens having a graded or variable tint, methods and molds of making the same. In one embodiment, the photochromic lens includes a lens element having a upper portion and a lower portion; and a UV-absorbing layer formed of a UV-absorbing material on a surface of the lens element, such that the UV-absorbing material is more concentrated at the lower portion of the lens element and less concentrated at the upper portion, thereby allowing more UV light to strike the photochromic at the upper portion of the lens element than at the lower portion. The lens element comprises a photochromic composition.

### CROSS-REFERENCE TO RELATED APPLICATION

This application claims priority to and the benefit of, pursuant to 35 U.S.C. §119(e), U.S. provisional patent application Ser. No. 61/942,246, filed Feb. 20, 2014, entitled “METHOD FOR MANUFACTURING LENSES WITH GRADED PHOTOCHROMIC AND LENSES MANUFACTURED THEREWITH”, by Kai C. Su, Leslie F. Stebbins, Dionisio Cruz and Jessica L. Gettings, which is incorporated herein in its entirety by reference.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference were individually incorporated by reference.

### FIELD OF THE INVENTION

The invention relates generally to lenses, and more particularly to lenses with graded photochromic, molds and methods of making same.

### BACKGROUND OF THE INVENTION

The background description provided herein is for the purpose of generally presenting the context of the present invention. The subject matter discussed in the background of the invention section should not be assumed to be prior art merely as a result of its mention in the background of the invention section. Similarly, a problem mentioned in the background of the invention section or associated with the subject matter of the background of the invention section should not be assumed to have been previously recognized in the prior art. The subject matter in the background of the invention section merely represents different approaches, which in and of themselves may also be inventions. Work of the presently named inventors, to the extent it is described in the background of the invention section, as well as aspects of the description that may not otherwise qualify as prior art at the time of filing, are neither expressly nor impliedly admitted as prior art against the present invention.

Photochromic lenses are typically made by evenly applying a photochromic coating to a plastic ophthalmic lens or by incorporating a photochromic compound in the lens matrix. The photochromic lens darkens when exposed to UV light, allowing the lenses to function as sunglasses, then fades when the UV light is removed.

One common problem associated with the conventional photochromic lenses is long fade time, in which when the wearer goes from outdoors in the sun to indoors, where the light is dimmer, the lenses do not fade immediately, making vision difficult. In addition, the conventional photochromic lenses may also make outdoor reading difficult.

Therefore, a heretofore unaddressed need exists in the art to address the aforementioned deficiencies and inadequacies.

### SUMMARY OF THE INVENTION

One of the objectives of the present invention is to provide a gradient photochromic lens that solves the aforementioned deficiencies and inadequacies by remaining clear in the lower (or bottom) portion of the photochromic lens. It would also facilitate outdoor reading and other activities in which clear eyesight is crucial.

In one aspect of the present invention, the photochromic lens includes a lens element having a upper portion and a lower portion; and a UV-absorbing layer formed of a UV-absorbing material on a surface of the lens element, such that the UV-absorbing material is more concentrated at the lower portion of the lens element and less concentrated at the upper portion, thereby allowing more UV light to strike the photochromic at the upper portion of the lens element than at the lower portion. In one embodiment, the lens element comprises a photochromic composition.

In one embodiment, the UV-absorbing layer has a thickness that is uniform from a bottom to a top of the UV-absorbing layer, or decreases gradually from a bottom to a top of the UV-absorbing layer.

In one embodiment, the photochromic lens further comprises a first coating formed over the UV-absorbing layer, where the first coating is a hard coat.

In another embodiment, the photochromic lens may also include a second coating formed on the lens element, where the UV-absorbing material is applied to the second coating on the lens element, and the second coating is a tintable hard coat.

In yet another embodiment, the photochromic lens may further include a hard coat layer formed on the lens element, where the second coating is applied over the hard coat layer on the lens element, and the UV-absorbing material is applied to the second coating overlaying the hard coat layer.

In one embodiment, the lens element comprises a lens blank including a semi-finished lens, a finished lens, or a wafer lens that is a portion of the lens, where the lens element is made of glass, or plastic.

In another aspect, the present invention relates to a method of forming a photochromic lens. In one embodiment, the method includes providing a lens element having a upper portion and a lower portion; and forming a graded or variable tint on a surface of the lens element by applying a UV-absorbing material to the lens element, wherein the UV-absorbing material is more concentrated at the lower portion of the lens element and less concentrated at the upper portion, thereby allowing more UV light to strike the photochromic at the upper portion of the lens element than at the lower portion. In one embodiment, the lens element comprises a photochromic composition.

In one embodiment, the UV-absorbing layer has a thickness that is uniform from a bottom to a top of the UV-absorbing layer, or decreases gradually from a bottom to a top of the UV-absorbing layer.

In one embodiment, the method further comprises forming a first coating over the UV-absorbing layer, wherein the first coating is a hard coat.

In another embodiment, the method also comprises forming a second costing on the lens element, where the UV-absorbing material is applied to the second coating on the lens element, and the second coating is a tintable hard coat.

In yet another embodiment, the method may also comprise forming a hard coat layer on the lens element, where the second coating is applied over the hard coat layer on the lens element, and the UV-absorbing material is applied to the second coating overlaying the hard coat.

In one embodiment, the step of applying the UV-absorbing material to the lens element comprises applying the UV-absorbing material to a coating on a lens mold that is used to cast or mold the photochromic lens. In one embodiment, the UV-absorbing material is applied to a front mold such that that UV-absorber is at or near the front of the photochromic lens. In another embodiment, the UV-absorbing material is applied to a back mold, so that the photochromic lens made therefrom have a graded or gradient darkening when exposed to UV-light from a backside of the photochromic lens.

In one embodiment, the lens element comprises a lens blank including a semi-finished lens, a finished lens, or a wafer lens that is a portion of the lens.

In yet another aspect, the present invention relates to a mold for forming a photochromic lens. In one embodiment, the mold has a front mold and a back mold, each mold defining an optical surface; a first coating on the optical surface of the front mold or the back mold, where the first coating is a hard coat; and a UV-absorbing layer formed of a UV-absorbing material on the first coating, such that the UV-absorbing material is more concentrated at a lower portion of the UV-absorbing layer and less concentrated at a upper portion of the UV-absorbing layer. In one embodiment, the hard coat is a tintable hard coat. In one embodiment, the mold may have a buffer coat overlaying the hard coat. In one embodiment, the front and back molds are formed of plastic.

In use, the front mold and the back mold are positioned to define a cavity therebetween in which a lens element is cast to form the photochromic lens. When cured, the coating and the UV-absorbing layer are transferred to the photochromic lens having a graded or variable tint, thereby allowing more UV light to strike the photochromic at the upper portion of the photochromic lens than at the lower portion of the photochromic lens. In one embodiment, the lens element comprises a photochromic composition.

In one embodiment, the UV-absorbing layer has a thickness that is uniform from a bottom to a top of the UV-absorbing layer, or decreases gradually from a bottom to a top of the UV-absorbing layer.

In one embodiment, the mold further has a second coating formed on the UV-absorbing layer.

In addition, in certain embodiments, the mold for forming the photochromic lens may have only the front mold as disclosed above. In use, instead of a back mold, a pre-formed lens or a portion of a lens forms the back side of the lens cavity. When cured, the coating and the UV-absorbing layer are transferred to the photochromic lens having a graded or variable tint, and the pre-formed lens or portion of a lens is attached thereto.

In a further aspect, the present invention relates to a method of forming a photochromic lens using the mold as disclosed above, where the front mold and the back mold are positioned to define a cavity therebetween. In one embodiment, the method comprises casting a lens element in the cavity; and curing the cast lens element to transfer the first coating and the UV-absorbing layer to the lens element to form the photochromic lens, so that the photochromic lens allows more UV light to strike the photochromic at the upper portion of the photochromic lens than at the lower portion of the photochromic lens. The lens element comprises a photochromic composition.

In one aspect, the present invention relates to a method forming a photochromic lens. In one embodiment, the method comprises providing a mold having a front mold and a back mold, each mold defining an optical surface, where the front mold and the back mold are adapted to define a cavity therebetween; forming a first coating on the optical surface of the front mold or the back mold, wherein the first coating is a hard coat; forming a UV-absorbing layer with a UV-absorbing material on the coating, such that the UV-absorbing material is more concentrated at a lower portion of the UV-absorbing layer and less concentrated at a upper portion of the UV-absorbing layer; casting a lens element in the cavity; and curing the cast lens element to transfer the first coating and the UV-absorbing layer to the lens element to form the photochromic lens, so that the photochromic lens allows more UV light to strike the photochromic at the upper portion of the photochromic lens than at the lower portion of the photochromic lens. In one embodiment, the hard coat is a tintable hard coat.

In one embodiment, the method further comprises forming a second coating formed on the UV-absorbing layer.

In another embodiment, the method also comprises forming a buffer coat overlaying the hard coat.

In one embodiment, the lens element comprises a photochromic composition. In one embodiment, the front and back molds are formed of plastic.

In one embodiment, the UV-absorbing layer has a thickness that decreases gradually from a bottom to a top of the UV-absorbing layer.

In one embodiment, the curing step is performed with UV-Visible light.

In another aspect, the present invention relates to a photochromic lens having a upper portion and a lower portion, comprising a graded or variable tint, such that the upper portion of the lens darkens when exposed to UV light, and the lower portion of the lens remains clear at all times.

In yet another aspect, the present invention relates to a photochromic lens having a upper portion and a lower portion, comprising a graded or variable tint, such that the lens darkens in a gradient of clear to dark from the lower portion to the upper portion.

In certain aspects, the present invention relates to a mold for forming the photochromic lens as disclosed above.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIGS. 1A-1D show photochromic lenses according to various embodiments of the present invention.

FIGS. 2A-2D show photochromic lenses according to various embodiments of the present invention.

FIGS. 3A-3D show photochromic lenses according to various embodiments of the present invention.

FIGS. 4A-4D show a mold and a process of making a photochromic lens therewith according to one embodiment of the present invention.

FIGS. 5A-5B show photochromic lenses according to various embodiments of the present invention.

### DETAILED DESCRIPTION OF THE INVENTION

The present disclosure will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terms used in this specification generally have their ordinary meanings in the art, within the context of the invention, and in the specific context where each term is used. Certain terms that are used to describe the invention are discussed below, or elsewhere in the specification, to provide additional guidance to the practitioner regarding the description of the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the invention or of any exemplified term. Likewise, the invention is not limited to various embodiments given in this specification.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, or “includes” and/or “including” or “has” and/or “having” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom”, “upper” or “top”, and “left” and “right”, may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper”, depending of the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the terms “comprise” or “comprising”, “include” or “including”, “carry” or “carrying”, “has/have” or “having”, “contain” or “containing”, “involve” or “involving” and the like are to be understood to be open-ended, i.e., to mean including but not limited to.

The description will be made as to the embodiments of the present invention in conjunction with the accompanying drawings. In accordance with the purposes of this invention, as embodied and broadly described herein, this invention, in certain aspects, relates to a method of creating a graded or variable tint on a photochromic lens, a photochromic lens made by the method, and a photochromic lens mold for making the photochromic lens.

In one embodiment, the photochromic lens is made such that the top of the lens darkens when exposed to UV light, but the bottom of the lens remains clear at all times. In another embodiment, the lens darkens such that there is a gradient of clear to dark from bottom to top.

By gradient is meant graded or variable where there is a variation in the darkness of the lens which may be quantitatively expressed as a percentage (%) of light transmittance. For example, where the light transmittance at the lens bottom is high, such as about 100%, or about 98%, or about 95%, the light transmittance at the upper portion of the lens are less than about 100%, or less than about 98%, or less than about 95%. That is, the light transmittance at the bottom of the lens is more than at the upper portion of the lens, and intermediate percent light transmittance is allowed at any intermediate regions of the lens between the upper and lower. In some cases, only two zones, that is of high and low transmittance are in the gradient lens. In other aspects, there may be an indeterminate number of gradations of light transmittance so as to provide a smooth continuation between high light transmittance at the bottom of the lens and low transmittance at the top of the lens.

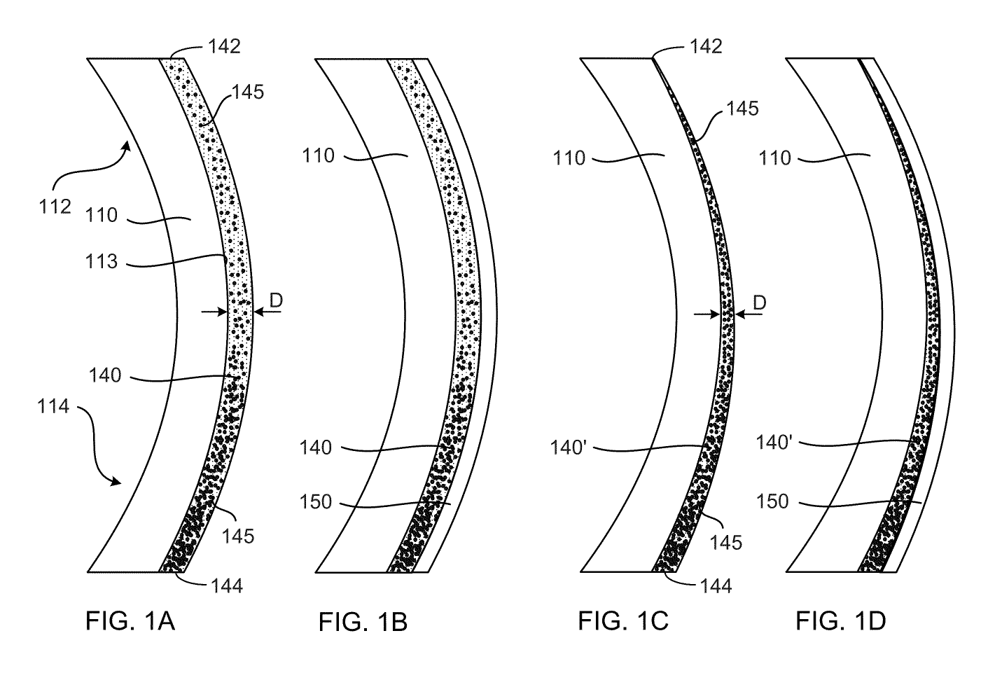

Referring to FIGS. 1A-1D, four photochromic lenses are respectively shown according to four embodiments of the present invention.

As shown in FIGS. 1A and 1C, the photochromic lens includes a lens element 110 having a upper portion 112 and a lower portion 114. The lens element 110 usually comprises a photochromic composition. The photochromic lens further includes a UV-absorbing layer 140 (140′) formed of a UV-absorbing material 145 on a surface 113 of the lens element 110.

Further, the photochromic lens may also have a first coating 150 formed over the UV-absorbing layer 140 (140′), as shown in FIGS. 1B and 1D. The first coating 150 can be a hard coat.

According to the invention, the UV-absorbing layer 140 (140′) is formed such that the UV-absorbing material 145 is more concentrated at the lower portion 114 of the lens element 110 and less concentrated at the upper portion 112, which allows more UV light to strike the photochromic at the upper portion 112 of the lens element 110 than at the lower portion 114. Accordingly, the photochromic lens has a graded or variable tint.

In one embodiment, the UV-absorbing material 145 is all concentrated at the lower portion 114 of the lens element 110, and no UV-absorbing material 145 is concentrated at the upper portion 114 of the lens element 110. For such a photochromic lens, the upper portion 112 of the lens darkens when exposed to UV light, while the lower portion 114 of the lens remains clear at all times.

In another embodiment, the concentration of the UV-absorbing material 145 is gradually reduced from the lower portion 114 of the lens element 110 to the upper portion 114 of the lens element 110. For this photochromic lens, it darkens in a gradient of clear to dark from the lower portion 114 to the upper portion 112 of the lens.

In certain embodiments, the UV-absorbing layer 140 has a thickness, D, that is uniform from a bottom 144 to a top 142 of the UV-absorbing layer 140, as shown in FIGS. 1A and 1B, where the UV-absorbing material 145 is more concentrated at the lower portion 114 of the lens element 110 and less concentrated at the upper portion 112.

In certain embodiments, the thickness D of the UV-absorbing layer 140′ decreases gradually from a bottom 144 to a top 142 of the UV-absorbing layer 140′, as shown in FIGS. 1C and 1D, where the concentration of the UV-absorbing material 145 is gradually reduced from the lower portion 114 of the lens element 110 to the upper portion 114 of the lens element 110.

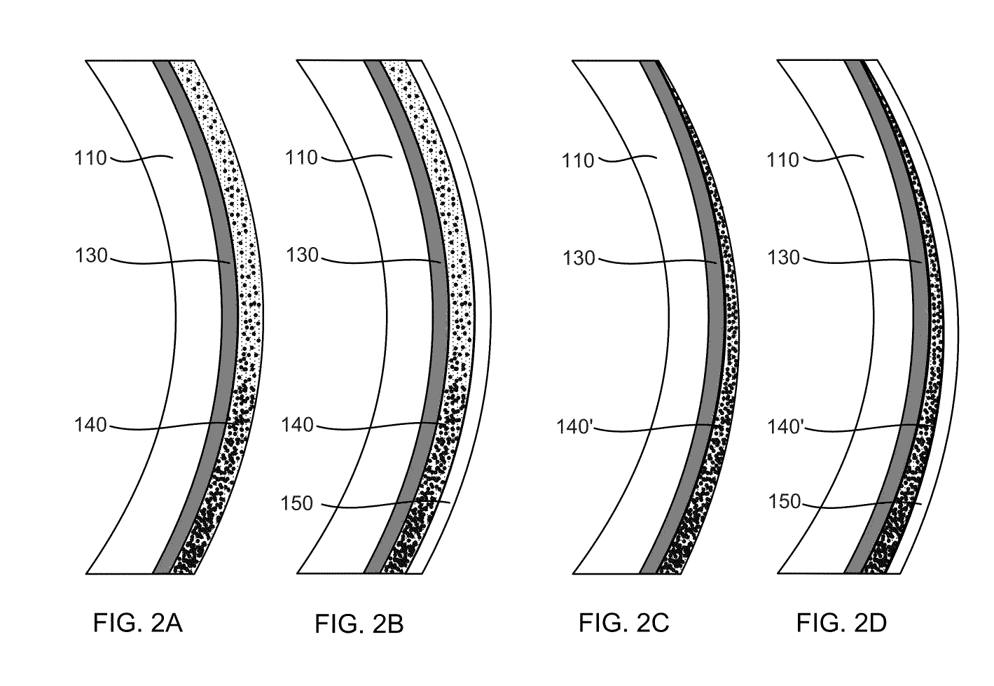

FIGS. 2A-2D show four photochromic lenses according to another four embodiments of the present invention, respectively. In addition to the structures of the photochromic lenses shown in FIGS. 1A-1D, the photochromic lenses shown in FIGS. 2A-2D also include a second coating 130 formed on the lens element 110, where the UV-absorbing material 145 is applied to the second coating 130 on the lens element 110. In certain embodiments, the second coating 130 is a tintable hard coat.

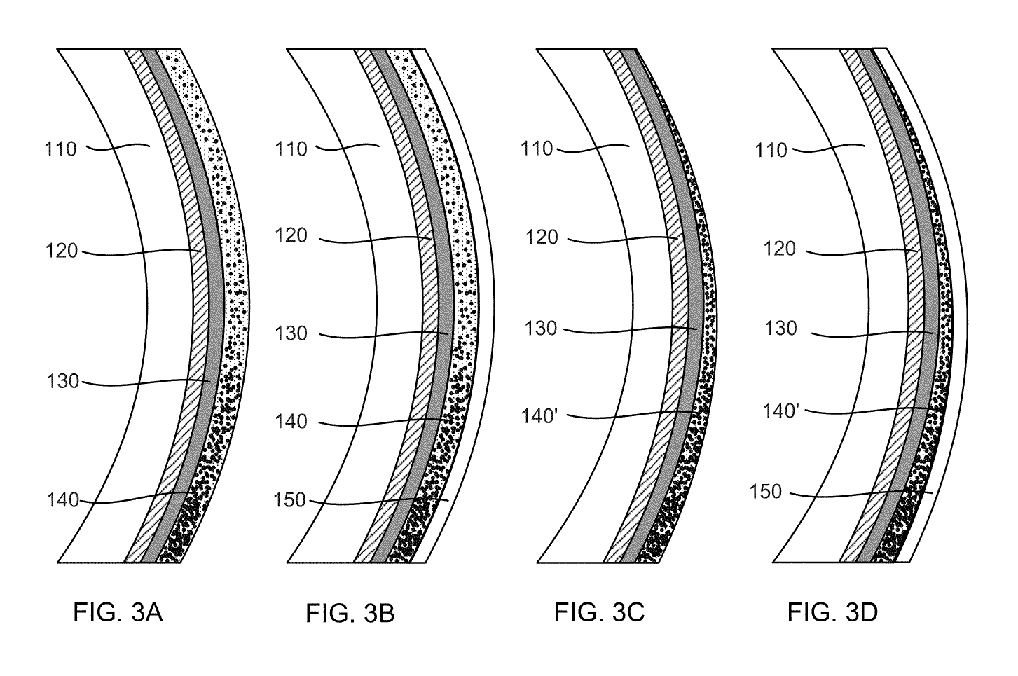

FIGS. 3A-3D show four photochromic lenses according to yet another four embodiments of the present invention, respectively. In addition to the structures of the photochromic lenses shown in FIGS. 2A-2D, the photochromic lenses shown in FIGS. 3A-3D further include a hard coat layer 120 formed on the lens element 110, where the second coating 130 is applied over the hard coat layer 120 on the lens element 110, and the UV-absorbing material 145 is applied to the second coating 130 overlaying the hard coat layer 120.

In certain embodiments, the lens element comprises a lens blank including a semi-finished lens, a finished lens, or a wafer lens that is a portion of the lens. The lens element is made of glass, or plastic.

In one aspect of the invention, the method of forming a photochromic lens includes providing a lens element having a upper portion and a lower portion; and forming a graded or variable tint on a surface of the lens element by applying a UV-absorbing material to the lens element, where the UV-absorbing material is more concentrated at the lower portion of the lens element and less concentrated at the upper portion, thereby allowing more UV light to strike the photochromic at the upper portion of the lens element than at the lower portion. In one embodiment, the lens element comprises a photochromic composition.

As discussed above, the UV-absorbing layer has a thickness that can be uniform from a bottom to a top of the UV-absorbing layer, or decreases gradually from a bottom to a top of the UV-absorbing layer.

Further, the method comprises forming a first coating over the UV-absorbing layer, where the first coating is a hard coat.

In addition, the method may also comprise forming a second costing on the lens element, where the UV-absorbing material is applied to the second coating on the lens element, and the second coating is a tintable hard coat.

Moreover, the method may comprise forming a hard coat layer on the lens element, where the second coating is applied over the hard coat layer on the lens element, and the UV-absorbing material is applied to the second coating overlaying the hard coat.

In certain embodiments, the step of applying the UV-absorbing material to the lens element comprises applying the UV-absorbing material to a coating on a lens mold that is used to cast or mold the photochromic lens. In one embodiment, the UV-absorbing material is applied to a front mold such that that UV-absorber is at or near the front of the photochromic lens. In certain embodiments, the UV-absorbing material is applied to a back mold, so that the photochromic lens made therefrom have a graded or gradient darkening when exposed to UV-light from a backside of the photochromic lens.

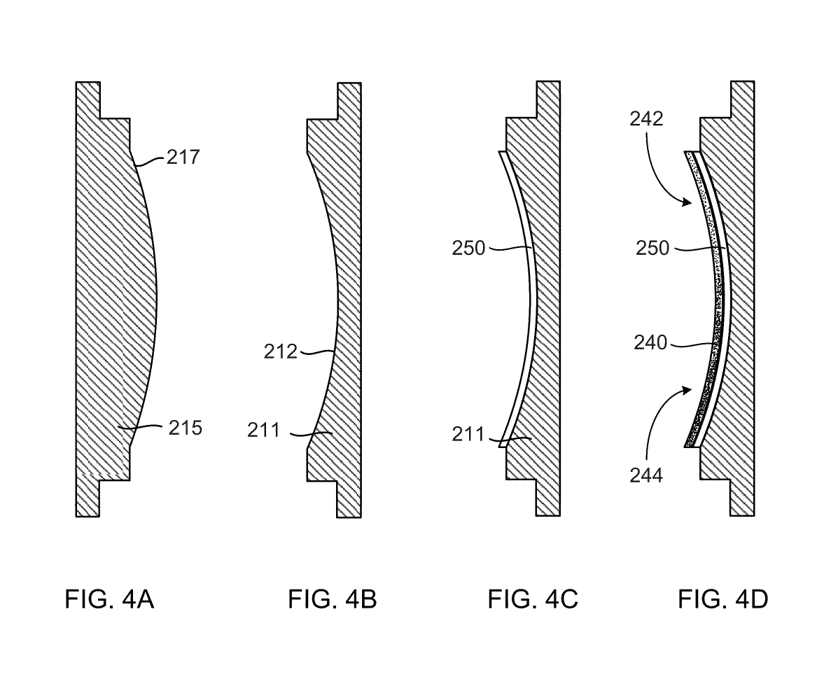

Referring to FIGS. 4A-4D, a mold and a process for forming a photochromic lens are shown according to one embodiment of the present invention. In one embodiment, the mold includes a front mold 211 having an optical surface 212, and a back mold 215 having an optical surface 217. In this exemplary embodiment, the front mold 211 has a concave surface 212 with a first curvature, and the back mold 215 has a convex surface 217 with a second curvature, as shown in FIGS. 4A-4B. The first curvature and the second curvature are substantially identical or different. If both the first curvature and the second curvature are identical, the concave surface 212 of the front lens mold 210 is substantially complementary to the convex surface 217 of the back mold 215. Each of the front mold 211 and the back mold 215 is formed of glass, plastic or metal. In one embodiment, the front mold 211 and the back mold 215 are formed of plastic. The lens mold may further have a gasket 219 such that when assembled, the gasket 219 seals the lens cavity (space) defined between the front mold 211 and the back mold 215.

Further, a first coating 250 is formed on the optical surface 212 or 217 of the front mold 211 or the back mold 215. In this embodiment, the first coating 250 is formed on the optical surface 212 of the front mold 211, as shown in FIG. 4C. The first coating 250 is a hard coat. In one embodiment, the hard coat is a tintable hard coat. In one embodiment, a polystyrene spectacle lens mold is spin-coated with a hard coat and then a buffer coat (Ebecryl 8402+UV-Cure Initiators) overlaying the hard coat.

Moreover, a UV-absorbing layer 240 is formed of a UV-absorbing material on the first coating 250. The UV-absorbing material is more concentrated at a lower portion 244 of the UV-absorbing layer 240 and less concentrated at an upper portion 242 of the UV-absorbing layer 240, as shown in FIG. 4D. In certain embodiments, the UV-absorbing layer 240 has a thickness that can be uniform from a bottom to a top of the UV-absorbing layer 240, or decreases gradually from a bottom to a top of the UV-absorbing layer 240.

In one embodiment, a bottom section of the coated mold is dipped into a heated solution of a UV Absorber in water (5% Lowilite® 20S in water, Addivant™, Danbury, Conn.). The mold is then blown dry.

In use, the front mold 211 and the back mold 215 are positioned to define a space (lens cavity) therebetween in which a photochromic lens composition 210 is cast to form the photochromic lens. A gasket, spacer or other means may be used to seal the lens cavity. When cured, the coating 250 and the UV-absorbing layer 240 are transferred to the photochromic lens having a graded or variable tint, thereby allowing more UV light to strike the photochromic at the upper portion of the photochromic lens than at the lower portion of the photochromic lens. In one embodiment, the cast lens element 210 is cured by UV-Visible light in the mold assembly for about 5 minutes. The photochromic lens is demolded and annealed at about 80° C. for about 20 minutes. The formed photochromic lens has the same structure as that shown in FIG. 2B.

Then, the lens element 110 of lens-forming fluid is cast into the cavity. The lens-forming fluid within the cavity is cured so as to form a photochromic lens having a graded or variable tint. Finally, the photochromic lens is obtained by removing the front mold 211, the back mold 215 and the gasket.

In certain embodiments, the lens element is a formulation that may be cured or polymerized to form a lens. For example, the formulation could be a mixture of monomers, polymers, oligomers and so forth such that when cured (polymerized), a hardened lens is formed. Lens formulations having reactive acrylate or methacrylate functional groups that can be cured by UV and/or visible light may be used. Heat curable formulations are another non-limiting example lens element formulation. When using plastic molds, the heat stability of the mold must be taken into consideration in selecting the type of lens formulation and the curing conditions so that the lens forming surface of the mold is not damaged by the casting and curing processes.

In certain embodiments, for a photochromic lens, the lens element formulation may contain one or more photochromic dyes, which will provide a so-called “in mass” photochromic lens after curing. Alternatively, a photochromic layer may be coated over the mold that has been previously coated with hard coat, optional buffer coat, and UV absorbing gradient layer. In this case, a non-photochromic lens element formulation may then be cast into the photochromic layered mold set and cured to provide a gradient photochromic lens. The mold may also contain a transferable anti-reflective coating and/or a polarized film, so that gradient photochromic lenses having anti-reflective and/or polarizing properties may be prepared by using the inventive concepts herein described.

In addition, in certain embodiments, the mold for forming the photochromic lens may have only the front mold as disclosed above and is devoid of a back mold. In use, instead of a back mold, a pre-formed lens or a portion of a lens forms the back side of the lens cavity. When cured, the coating and the UV-absorbing layer are transferred to the photochromic lens having a graded or variable tint, and the pre-formed lens or portion of a lens is attached thereto.

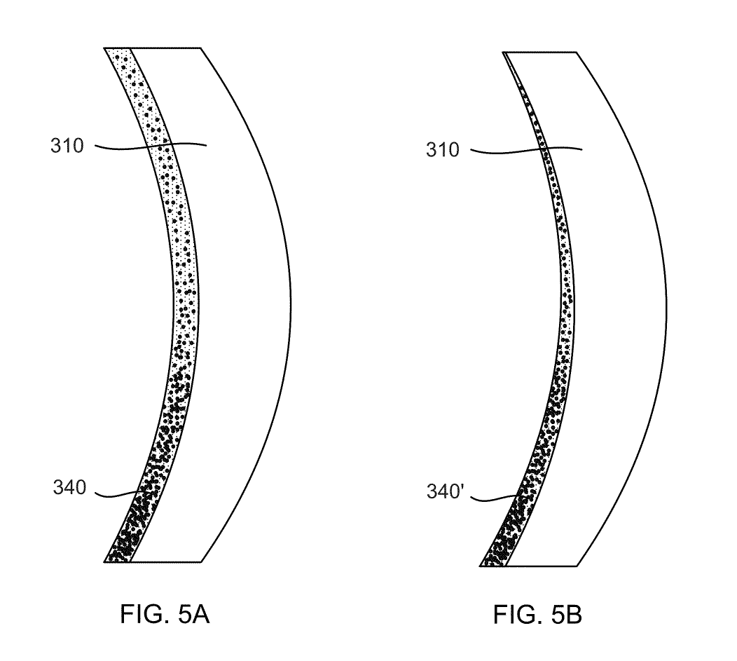

According to certain embodiments of the invention, the UV-absorbing material 340 (340′) can also be applied to a back mold, so that the photochromic lens made therefrom have a graded or gradient darkening when exposed to UV-light from a backside of the photochromic lens element 310, as shown in FIGS. 5A-5B.

In one aspect, the present invention relates to a method of forming a photochromic lens using the mold as disclosed above, where the front mold and the back mold are positioned to define a cavity therebetween. In one embodiment, the method comprises casting a lens element in the cavity; and curing the cast lens element to transfer the first coating and the UV-absorbing layer to the lens element to form the photochromic lens, so that the photochromic lens allows more UV light to strike the photochromic at the upper portion of the photochromic lens than at the lower portion of the photochromic lens. The lens element comprises a photochromic composition.

In another aspect, the present invention relates to a method forming a photochromic lens. The method comprises the following steps: At first, a mold having a front mold and a back mold is provided, where each mold defines an optical surface, and the front mold and the back mold are adapted to define a cavity therebetween.

Then, a first coating is formed on the optical surface of the front mold or the back mold, where the first coating is a hard coat. In one embodiment, the hard coat is a tintable hard coat.

Next, a UV-absorbing layer is formed of a UV-absorbing material on the coating, such that the UV-absorbing material is more concentrated at a lower portion of the UV-absorbing layer and less concentrated at an upper portion of the UV-absorbing layer.

Further, a lens element including a photochromic composition is cast in the cavity.

Finally, the cast lens element is cured so as to transfer the first coating and the UV-absorbing layer to the lens element to form the photochromic lens. As such, the photochromic lens allows more UV light to strike the photochromic at the upper portion of the photochromic lens than at the lower portion of the photochromic lens.

In one embodiment, the method further comprises forming a second coating formed on the UV-absorbing layer.

In another embodiment, the method also comprises forming a buffer coat overlaying the hard coat.

In one embodiment, the curing step is performed with UV-Visible light.

In yet another aspect of the present invention, the photochromic lens having a upper portion and a lower portion, comprises a graded or variable tint, such that the upper portion of the lens darkens when exposed to UV light, and the lower portion of the lens remains clear at all times.

In a further aspect of the present invention, the photochromic lens having a upper portion and a lower portion, comprises a graded or variable tint, such that the lens darkens in a gradient of clear to dark from the lower portion to the upper portion.

In certain aspects, the present invention relates to a mold for forming the photochromic lens as disclosed above.

In sum, the invention recites, among other things, a photochromic lens having a graded or variable tint, methods and molds of making the same. The photochromic lens includes a UV-absorbing layer formed of a UV-absorbing material on a surface of the lens element, such that the UV-absorbing material is more concentrated at the lower portion of the lens element and less concentrated at the upper portion, thereby allowing more UV light to strike the photochromic at the upper portion of the lens element than at the lower portion. Accordingly, the upper portion of the lens darkens when exposed to UV light and the lower portion of the lens remains clear at all times, or the lens darkens in a gradient of clear to dark from the lower portion to the upper portion when exposed to UV light.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A photochromic lens, comprising:
a lens element having a upper portion and a lower portion; and
a UV-absorbing layer formed of a UV-absorbing material on a surface of the lens element, such that the UV-absorbing material is more concentrated at the lower portion of the lens element and less concentrated at the upper portion, thereby allowing more UV light to strike the photochromic at the upper portion of the lens element than at the lower portion.

2. The photochromic lens of claim 1, wherein the lens element comprises a photochromic composition.

3. The photochromic lens of claim 1, wherein the UV-absorbing layer has a thickness that is uniform from a bottom to a top of the UV-absorbing layer, or decreases gradually from a bottom to a top of the UV-absorbing layer.

4. The photochromic lens of claim 1, further comprising a first coating formed over the UV-absorbing layer, wherein the first coating is a hard coat.

5. The photochromic lens of claim 1, further comprising a second coating formed on the lens element, wherein the UV-absorbing material is applied to the second coating on the lens element.

6. The photochromic lens of claim 5, wherein the second coating is a tintable hard coat.

7. The photochromic lens of claim 4, further comprising a hard coat layer formed on the lens element, wherein the second coating is applied over the hard coat layer on the lens element, and the UV-absorbing material is applied to the second coating overlaying the hard coat layer.

8. The photochromic lens of claim 1, wherein the lens element comprises a lens blank including a semi-finished lens, a finished lens, or a wafer lens that is a portion of the lens.

9. The photochromic lens of claim 8, wherein the lens element is made of glass, or plastic.

10. A method of forming a photochromic lens, comprising:
providing a lens element having a upper portion and a lower portion; and
forming a graded or variable tint on a surface of the lens element by applying a UV-absorbing material to the lens element, wherein the UV-absorbing material is more concentrated at the lower portion of the lens element and less concentrated at the upper portion, thereby allowing more UV light to strike the photochromic at the upper portion of the lens element than at the lower portion.

11. The method of claim 10, wherein the lens element comprises a photochromic composition.

12. The method of claim 10, wherein the UV-absorbing layer has a thickness that is uniform from a bottom to a top of the UV-absorbing layer, or decreases gradually from a bottom to a top of the UV-absorbing layer.

13. The method of claim 10, further comprising forming a first coating over the UV-absorbing layer, wherein the first coating is a hard coat.

14. The method of claim 10, further comprising forming a second coating on the lens element, wherein the UV-absorbing material is applied to the second coating on the lens element.

15. The method of claim 14, wherein the second coating is a tintable hard coat.

16. The method of claim 14, further comprising forming a hard coat layer on the lens element, wherein the second coating is applied over the hard coat layer on the lens element, and the UV-absorbing material is applied to the second coating overlaying the hard coat.

17. The method of claim 10, where the step of applying the UV-absorbing material to the lens element comprises applying the UV-absorbing material to a coating on a lens mold that is used to cast or mold the photochromic lens.

18. The method of claim 17, wherein the UV-absorbing material is applied to a front mold such that that UV-absorber is at or near the front of the photochromic lens.

19. The method of claim 17, wherein the UV-absorbing material is applied to a back mold, so that the photochromic lens made therefrom has a graded or gradient darkening when exposed to UV-light from a backside of the photochromic lens.

20. The method of claim 10, wherein the lens element comprises a lens blank including a semi-finished lens, a finished lens, or a wafer lens that is a portion of the lens.

21. A mold for forming a photochromic lens, comprising:
a front mold and a back mold, each mold defining an optical surface;
a first coating on the optical surface of the front mold or the back mold, wherein the first coating is a hard coat; and
a UV-absorbing layer formed of a UV-absorbing material on the first coating, such that the UV-absorbing material is more concentrated at a lower portion of the UV-absorbing layer and less concentrated at a upper portion of the UV-absorbing layer.

22. The mold of claim 21, wherein the UV-absorbing layer has a thickness that is uniform from a bottom to a top of the UV-absorbing layer, or decreases gradually from a bottom to a top of the UV-absorbing layer.

23. The mold of claim 21, further comprising a second coating formed on the UV-absorbing layer.

24. The mold of claim 21, wherein the hard coat is a tintable hard coat.

25. The mold of claim 21, further comprising a buffer coat overlaying the hard coat.

26. The mold of claim 21, wherein in use, the front mold and the back mold are positioned to define a cavity therebetween in which a lens element is cast to form the photochromic lens.

27. The mold of claim 26, wherein when cured, the coating and the UV-absorbing layer are transferred to the photochromic lens having a graded or variable tint, thereby allowing more UV light to strike the photochromic at the upper portion of the photochromic lens than at the lower portion of the photochromic lens.

28. The mold of claim 26, wherein the lens element comprises a photochromic composition.

29. The mold of claim 21, wherein the front and back molds are formed of plastic.

30. A method of forming a photochromic lens using the mold of claim 21, wherein the front mold and the back mold are positioned to define a cavity therebetween, comprising:
casting a lens element in the cavity; and
curing the cast lens element to transfer the first coating and the UV-absorbing layer to the lens element to form the photochromic lens, so that the photochromic lens allows more UV light to strike the photochromic at the upper portion of the photochromic lens than at the lower portion of the photochromic lens.

31. The method of claim 30, wherein the lens element comprises a photochromic composition.

32. A method of forming a photochromic lens, comprising:
providing a mold having a front mold and a back mold, each mold defining an optical surface, wherein the front mold and the back mold are adapted to define a cavity therebetween;
forming a first coating on the optical surface of the front mold or the back mold, wherein the first coating is a hard coat;
forming a UV-absorbing layer with a UV-absorbing material on the coating, such that the UV-absorbing material is more concentrated at a lower portion of the UV-absorbing layer and less concentrated at a upper portion of the UV-absorbing layer;
casting a lens element in the cavity; and
curing the cast lens element to transfer the first coating and the UV-absorbing layer to the lens element to form the photochromic lens, so that the photochromic lens allows more UV light to strike the photochromic at the upper portion of the photochromic lens than at the lower portion of the photochromic lens.

33. The method of claim 32, further comprising forming a second coating on the UV-absorbing layer.

34. The method of claim 32, wherein the hard coat is a tintable hard coat.

35. The method of claim 32, further comprising forming a buffer coat overlaying the hard coat.

36. The method of claim 32, wherein the lens element comprises a photochromic composition.

37. The method of claim 32, wherein the front and back molds are formed of plastic

38. The method of claim 32, wherein the UV-absorbing layer has a thickness that decreases gradually from a bottom to a top of the UV-absorbing layer.

39. The method of claim 32, wherein the curing step is performed with UV-Visible light.

40. A photochromic lens having a upper portion and a lower portion, comprising a graded or variable tint, such that the upper portion of the lens darkens when exposed to UV light, and the lower portion of the lens remains clear at all times.

41. A mold for forming the photochromic lens of claim 40.

42. A photochromic lens having a upper portion and a lower portion, comprising a graded or variable tint, such that the lens darkens in a gradient of clear to dark from the lower portion to the upper portion.

43. A mold for forming the photochromic lens of claim 42.
